(19) United States
(12) Patent Application Publication
(10) Pub. No.: US 2026/0149222 A1
(43) Pub. Date: May 28, 2026

(54) ELECTRICAL CONNECTOR HAVING A SEAL RETAINER

(71) Applicant: TE Connectivity Solutions GmbH, Schaffhausen (CH)

(72) Inventors: Lindsey Ballas, Winston Salem, NC (US); Raghunandan Shrikanth Shanbhag, Bangalore (IN); Ryan David Hetrick, Middletown, PA (US)

(21) Appl. No.: 19/013,374

(22) Filed: Jan. 8, 2025

(30) Foreign Application Priority Data
Nov. 28, 2024 (IN) 202441093068

(51) Int. Cl. H01R 13/52; H01R 13/436

(52) U.S. Cl. CPC H01R 13/5219; H01R 13/436; H01R 2201/26

(57) ABSTRACT

An electrical connector includes a housing having walls forming a cavity. The housing includes a seal pocket at a mating end. The electrical connector includes a terminal received in the housing at a fully loaded position configured to be mated with the mating electrical connector in the fully loaded position. The electrical connector includes a peripheral seal received in the seal pocket sealed to the housing and configured to be sealed to the mating housing when mated with the mating housing. The electrical connector includes a seal retainer received in the seal pocket having an inner surface configured to interface with the peripheral seal and hold the peripheral seal in the seal pocket. The seal retainer includes a TPA device configured to interface with the terminal in the housing to assure positioning of the terminal in the housing at the fully loaded position.

### CROSS REFERENCE TO RELATED APPLICATIONS

This application claims benefit to IN Application No. 202441093068, filed 28 Nov. 2024, the subject matter of which is herein incorporated by reference in its entirety.

### BACKGROUND OF THE INVENTION

The subject matter herein relates generally to a seal retainer for an electrical connector.

Connector systems use electrical connectors to interconnect various components. Some connector systems transmit power and or data from one component to another component. For instance, power connectors may be used to connect a power source, such as a battery, to a load, such as a motor. For example, in an electric vehicle, the battery may be connected to the invertor or electric motor through a plug connector and a header connector. The header connector is mounted to one of the components, such as the motor, and the plug connector is provided at an end of a cable harness routed between the batter and the plug connector. Some connector systems may be used in harsh environments, and thus require a sealed mating interface. There is a need to position a peripheral seal at the connector interface. If the seal is improperly positioned, the sealed interface may be corrupted.

### BRIEF DESCRIPTION OF THE INVENTION

In one embodiment, an electrical connector is provided and includes a housing that has walls forming a cavity. The housing has a mating end configured to be mated with a mating electrical connector. The housing includes a seal pocket at the mating end. The electrical connector includes a terminal received in the housing at a fully loaded position and is configured to be mated with the mating electrical connector in the fully loaded position. The electrical connector includes a peripheral seal received in the seal pocket. The peripheral seal is sealed to the housing and configured to be sealed to the mating housing when mated with the mating housing. The electrical connector includes a seal retainer received in the seal pocket. The seal retainer includes an inner surface configured to interface with the peripheral seal and holds the peripheral seal in the seal pocket. The seal retainer includes a terminal position assurance device. The terminal position assurance device of the seal retainer is configured to interface with the terminal in the housing to assure positioning of the terminal in the housing at the fully loaded position.

In another embodiment, an electrical connector is provided and includes a housing that has walls forming a cavity. The housing has a mating end configured to be mated with a mating electrical connector. The housing includes a terminal channel. The housing includes a seal pocket at the mating end. The electrical connector includes a terminal received in the terminal channel of the housing to a fully loaded position. The terminal configured to be mated with the mating electrical connector in the fully loaded position. The electrical connector includes a peripheral seal received in the seal pocket. The peripheral seal is sealed to the housing and configured to be sealed to the mating housing when mated with the mating housing. The electrical connector includes a seal retainer includes a frame received in the seal pocket. The frame has an inner surface configured to interface with the peripheral seal and holds the peripheral seal in the seal pocket. The seal retainer includes a terminal position assurance device extending from the frame. The terminal position assurance device includes a finger configured to be received in the terminal channel to interface with the terminal to assure positioning of the terminal in the housing at the fully loaded position.

In a further embodiment, an electrical connector is provided and includes a housing that has walls forming a cavity. The housing has a mating end configured to be mated with a mating electrical connector. The housing includes a seal pocket at the mating end. The electrical connector includes a terminal received in the housing at a fully loaded position. The terminal is configured to be mated with the mating electrical connector in the fully loaded position. The electrical connector includes a peripheral seal received in the seal pocket. The peripheral seal is sealed to the housing and configured to be sealed to the mating housing when mated with the mating housing. The electrical connector includes a seal retainer includes a frame received in the seal pocket. The frame has an inner surface configured to interface with the peripheral seal and holds the peripheral seal in the seal pocket. The frame includes a nested portion and a sliding portion. The sliding portion is movable relative to the nested portion between an extended position and an actuated position. The seal retainer includes a terminal position assurance device extending from the sliding portion of the frame. The terminal position assurance device moves with the sliding portion from the extended position to the actuated position and configured to interface with the terminal in the actuated position to assure positioning of the terminal in the housing at the fully loaded position.

### BRIEF DESCRIPTION OF THE DRAWINGS

FIG. 1 is a perspective view of an electrical connector system in accordance with an exemplary embodiment.

FIG. 2 is a bottom perspective view of a portion of the electrical connector (for example, the plug connector) configured to be mated with the electrical connector shown in FIG. 1 in accordance with an exemplary embodiment.

FIG. 3 is a bottom perspective view of the seal retainer showing the TPA device in an extended position in accordance with an exemplary embodiment.

FIG. 4 is a bottom perspective view of the seal retainer showing the TPA device in an actuated position in accordance with an exemplary embodiment.

FIG. 5 is an exploded view of the electrical connector in accordance with an exemplary embodiment showing the housing holding the terminals and showing the peripheral seal and the seal retainer poised for loading into the housing.

FIG. 6 is a bottom perspective, assembled view of a portion of the electrical connector showing the seal retainer in an extended position.

FIG. 7 is a bottom perspective, assembled view of a portion of the electrical connector showing the seal retainer in an actuated position.

FIG. 8 shows locking fingers of the TPA device in unblocking positions.

FIG. 9 shows locking fingers of the TPA device in blocking positions.

### DETAILED DESCRIPTION OF THE INVENTION

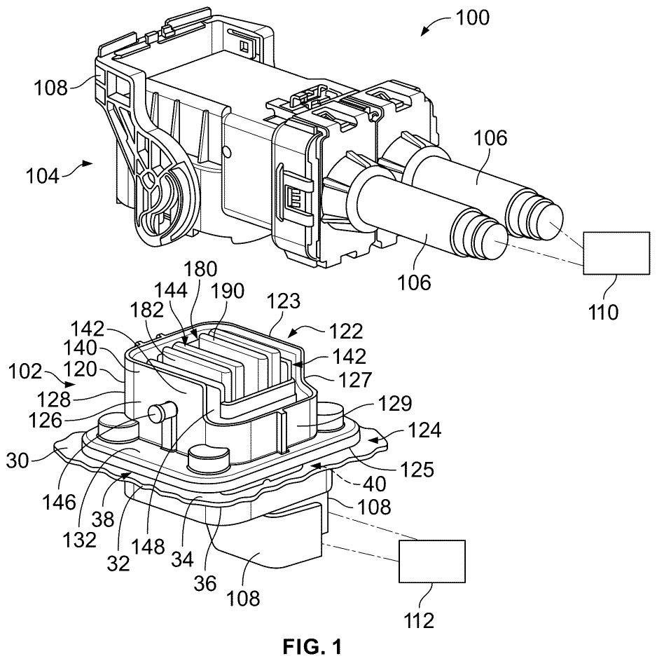

FIG. 1 is a perspective view of an electrical connector system 100 in accordance with an exemplary embodiment. The electrical connector system 100 includes electrical connectors 102, 104 configured to be mated at a separable mating interface. In an exemplary embodiment, the electrical connectors 102, 104 are a header connector 102 and a plug connector 104, respectively. The plug connector 104 is a mating electrical connector configured to be mated with the header connector 102. The plug connector 104 is shown poised for mating with the header connector 102.

The header connector 102 is mounted to a structure 30 of a component. The structure 30 may be a panel, frame, chassis, or other mounting structure of a vehicle, such as an electric vehicle. However, the header connector 102 may be utilized in other applications, such as an aeronautical application, a marine application, an industrial application, a computer application, and the like. In an exemplary embodiment, the structure 30 is a panel 32 having a first or upper surface 34 and a second or lower surface 36. The panel 32 has a mounting area 38 and the header connector 102 is configured to be mounted to the panel 32 at the mounting area 38. In an exemplary embodiment, the panel 32 includes an opening 40 at the mounting area 38. The header connector 102 is received in the opening 40 and mounted to the panel 32 at the mounting area 38. In an exemplary embodiment, the panel 32 is conductive. For example, the panel 32 may be manufactured from a metal material, such as steel. The panel 32 may be a piece of sheet metal. In an exemplary embodiment, the panel 32 is a coated structure wherein one or more layers of the panel are coated layers. The panel 32 may be oriented horizontally such that the first surface 34 is an upper surface and the second surface 36 is a lower surface; however, other orientations are possible in alternative embodiments.

In an exemplary embodiment, the electrical connector system 100 is a high power connector system that is used to transfer power between various components as part of a high power circuit. In a particular application, the electrical connector system 100 is a battery system, such as a battery system of a vehicle, such as an electric vehicle or hybrid electric vehicle; however, the electrical connector system 100 is not intended to be limited to such battery systems.

The plug connector 104 is configured to be electrically connected to a component 110, such as through one or more power cables 106. For example, the plug connector 104 may be electrically connected to a battery, a charger, an inverter, an electric motor or another type of component. The header connector 102 is configured to be electrically connected to a component 112, such as through a power bus; however the header connector 102 may be electrically connected to the component 112 by other means, such as a terminal, power wire or other connector. For example, the header connector 102 may be electrically connected to a battery pack, such as through a battery distribution unit, a manual service disconnect, a charger, an inverter, an electric motor, or another type of component. The battery distribution unit may manage the power capacity and functionality of the electrical connector system 100, such as by measuring current and regulating power distribution of the battery pack.

In the illustrated embodiment, the electrical connector system 100 is a right angle connector system where the connectors 102, 104 are mated in a direction perpendicular to the power wires 106. However, the power wires 106 may extend from the plug connector 104 in a direction parallel to the mating direction in alternative embodiments. In various embodiments, the mating direction is a vertical mating direction. For example, the plug connector 104 is mated to the header connector 102 in a vertically downward direction. Optionally, the plug connector 104 may be removably coupled to the header connector 102 to disconnect the high power circuit of one or more of the components, such as the battery pack, the electric motor, the inverter, or other components of the vehicle, such as for maintenance, repair or for another reason. When mated, one or more header contacts of the header connector 102 are mated with corresponding plug terminals of the plug connector 104, such as at mating interfaces thereof.

The header connector 102 includes a header housing 120 and a contact assembly 180. The header housing 120 holds the contact assembly 180. The contact assembly 180 is configured to be mated with the plug connector 104 to make an electrical connection with the plug connector 104. The contact assembly 180 is configured to be electrically connected to the component 112, such as by a busbar, a cable, wires, or other types of electrical connectors.

The header housing 120 has a mating end 122 at a top 123 of the header housing 120 and a mounting end 124 at a bottom 125 of the header housing 120. The header housing 120 includes a base 130 at the mounting end 124 and a shroud 140 extending from the base 130. The shroud 140 is provided at the mating end 122 and surrounds the contact assembly 180. The shroud 140 includes shroud walls 142 surrounding a cavity 144. The cavity 144 receives the contact assembly 180. The shroud walls 142 extend along first and second sides 126, 127 of the header housing 120 and extend along a front 128 and a rear 129 of the header housing 120. As such, the contact assembly 180 is surrounded on all four sides. Optionally, the shroud walls 142 at the rear 129 may be shorter than the shroud walls 142 at the front 128. The shroud walls 142 may include guide features, such as tabs, ribs, or channels extending along the shroud walls 142 to guide mating with the plug connector 104. The shroud 140 is configured to be plugged into the plug connector 104.

In an exemplary embodiment, the shroud 140 includes mounting pins 146 extending from the shroud walls 142. The plug connector 104 is configured to be mounted to the mounting pins 146. For example, a lever 108, which is rotatably coupled to the housing of the plug connector 104, is configured to be coupled to the mounting pins 146.

In an exemplary embodiment, a header shield 148 is coupled to the header housing 120. The header shield 148 may be coupled to the shroud 140 and/or the base 130. The header shield 148 is configured to be electrically connected to the plug connector 104 when the plug connector 104 is coupled to the header connector 102. In an exemplary embodiment, the header shield 148 is configured to be electrically connected to the panel 32 to electrically common the plug connector 104 with the panel 32. The header shield 148 may provide shielding around the contact assembly 180. In an exemplary embodiment, the header shield 148 extends along interior surfaces of the shroud walls 142. Optionally, the header shield 148 may extend from the shroud 140 into the base 130. For example, the header shield 148 may be wrapped around the base 130 to an exterior of the base 130 to electrically connect to the panel 32.

In an exemplary embodiment, the contact assembly 180 includes a contact holder 182 holding one or more header contacts 190. For example, the header contact 190 may be received in contact channels passing through the contact holder 182. The header contacts 190 may be socket contacts, pin contacts, blade contacts, spring beam contacts, or other types of contacts. In an exemplary embodiment, the header contacts 190 include busbars made from a metal plate having planar side surfaces extending from a mating edge. The busbars may be mated with the plug connector 104. In other various embodiments, the header contacts 190 may include socket contacts, such as having one or more contacts forming a socket configured to receive a pin or blade or busbar of the plug connector 104. In various embodiments, the header contacts 190 may include a stack of contact plates, such as dual socket contact plates configured to receive blades or edges of busbars at both sides of the stack of plate contacts.

The contact holder 182 is manufactured from a dielectric material to isolate the header contact 190 from each other and from the header shield 148. In the illustrated embodiment, the contact holder 182 is separate and discrete from the header housing 120. However, in alternative embodiments, the contact holder 182 may be integral with the header housing 120 such as being co-molded with the header housing 120. For example, the header housing 120 may be molded with contact channels in the base 130 that receive the header contact 190. In such embodiments, the header housing 120 directly holds the contacts 190.

The base 130 holds the contact assembly 180. For example, the contact assembly 180 may be plugged into the base 130. The base 130 may include an opening or channels that receive portions of the contact assembly 180. The base 130 is configured to be mounted to the panel 32. Optionally, the base 130 may extend through the opening 134 such that the base 130 is located both above the upper surface 34 and below the lower surface 36 of the panel 32. In an exemplary embodiment, the base 130 includes a flange 132 extending outward from the base 130. The base 130 is configured to be plugged through the opening 40 in the panel 32. The flange 132 is configured be mounted to the panel 32 at the mounting area 38. For example, the flange 132 faces the upper surface 34 of the panel 32. In an exemplary embodiment, the flange 132 abuts against a mounting surface at the upper surface 34 of the mounting area 38. In an exemplary embodiment, a sealed interface is defined between the header connector 102 and the panel 32, such as at the bottom surface of the flange 132 and the upper surface 34 of the panel 32. The seal at the sealed interface may be compressed between the panel 32 and the flange 132.

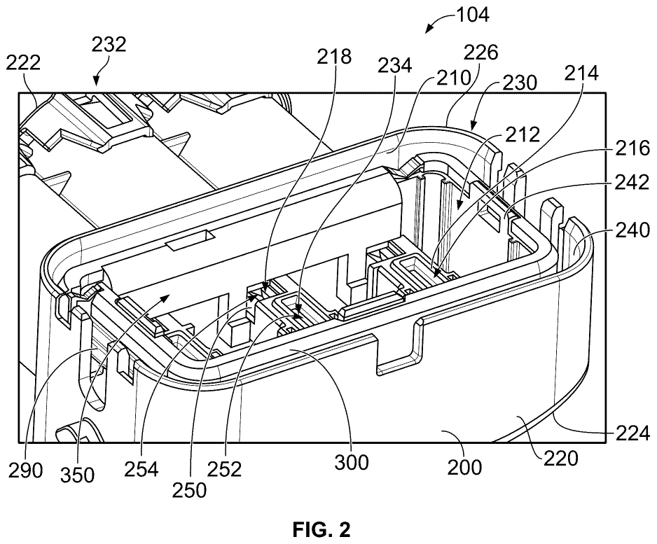

FIG. 2 is a bottom perspective view of a portion of the electrical connector 104 (for example, the plug connector 104) configured to be mated with the electrical connector 102 shown in FIG. 1. The electrical connector 104 includes a housing 200 holding terminals 250. The terminals 250 are configured to be mated with the header contacts 190 of the header connector 102 (shown in FIG. 1). In an exemplary embodiment, the electrical connector 104 includes a peripheral seal 290 configured to be sealed to the housing 200 and configured to be sealed to the header housing 120.

In an exemplary embodiment, the electrical connector 104 includes a seal retainer 300 configured to hold the peripheral seal 290 in the housing 200. In an exemplary embodiment, the seal retainer 300 includes a terminal position assurance (TPA) device 350 configured to interface with the terminal(s) 250 to assure positioning of the terminal(s) 250 in the housing 200. In an exemplary embodiment, the TPA device 350 operates as a secondary locking feature to lock the terminal(s) 250 in the housing 200.

The housing 200 includes walls 210 forming a cavity 212. The cavity 212 may receive the terminals 250. The cavity 212 may receive the TPA device 350. The cavity 212 may receive a portion of the header connector 102, such as the contact holder 182 and/or the contacts 190. The housing 200 extends between a front 220 and a rear 222. The housing 200 extends between a top 224 and a bottom 226. In an exemplary embodiment, the electrical connector 104 has a mating end 230 and a cable end 232. The mating end 230 is configured to be mated with the header connector 102. In the illustrated embodiment, the mating end 230 is provided at the bottom 226. Other locations are possible in alternative embodiments. The cables 106 extend from the cable end 232. In the illustrated embodiment, the cable end 232 is provided at the rear 222. Other locations are possible in alternative embodiments.

In an exemplary embodiment, the housing 200 includes terminal channels 234 that hold the terminals 250. The terminal channels 234 may be open at the rear 222 to receive the terminals 250 into the terminal channels 234 through the rear 222.

In an exemplary embodiment, the walls 210 include mating portions 214 extending into the cavity 212. The mating portions 214 are configured to be mated with the header connector 102. The terminal channels 234 may extend into the mating portions 214 to position the terminals 250 in the mating portions 214 for mating with the header contacts 190.

In an exemplary embodiment, the mating portions 214 includes slots 216 open to the terminal channels 234. The slots 216 may receive mating ends of the header contacts 190 to allow mating with the terminals 250. For example, the slots 216 may be aligned with sockets of the terminals 250 for mating of the terminals 250 and the header contacts 190. In other various embodiments, the terminals 250 may extend through the slots 216 to mate with the header contacts 190. For example, the mating ends of the terminals 250 may be blades or busbars passing through the slots 216 and protruding from the mating portions 214 for mating with the header contacts 190.

In an exemplary embodiment, the mating portions 214 include openings 218 open to the terminal channels 234. The terminals 250 are exposed in the openings 218. In an exemplary embodiment, the TPA device 350 is configured to be received in the openings 218 to interface with the terminals 250.

In an exemplary embodiment, the housing 200 includes a seal pocket 240 at the mating end 230. The seal pocket 240 is configured to receive the peripheral seal 290 and the seal retainer 300. The peripheral seal 290 is configured to be sealed to the housing 200 in the seal pocket 240. The seal pocket 240 extends circumferentially around the cavity 212. The seal pocket 240 is open at the bottom 226 such that the peripheral seal 290 is able to interface with the header connector 102 during mating. In an exemplary embodiment, the housing 200 includes one or more latches 242 in or around the seal pocket 240. The latches 242 are used to hold the seal retainer 300 in the seal pocket 240.

The terminals 250 are received in the terminal channels 234. The terminal 250 is configured to be loaded into the terminal channel 234 through the rear 222. The terminal 250 is loaded to a fully loaded position. For example, the terminal 250 is loaded in a forward loading direction and may bottom out against a surface or wall of the housing 200. In an exemplary embodiment, the housing 200 includes a primary latch (not shown) configured to lock the terminal 250 in the terminal channel 234. In an exemplary embodiment, the TPA device 350 is configured to interface with the terminal 250, in the fully loaded position, to lock the terminal 250 in the terminal channel 234. The TPA device 350 functions as a secondary lock to secure the terminal 250 in the terminal channel 234, such as if the primary latch fails.

Each terminal 250 includes a mating end 252 and a terminating end 254. The mating end 252 is positioned at the mating end 230, such as in the mating portion 214 for mating with the header contact 190. In the illustrated embodiment, the mating end 252 includes a socket, such as a box-shaped socket. The socket may have other shapes, such as cylindrical. The mating end 252 may have other types of contact interfaces, such as a pin, a blade, a spring beam, and the like. The terminating end 254 is configured to be terminated to corresponding cable 106. For example, the terminating end 254 may include a crimp barrel configured to be crimped to the cable 106 or a weld pad configured to be welded to the cable 106.

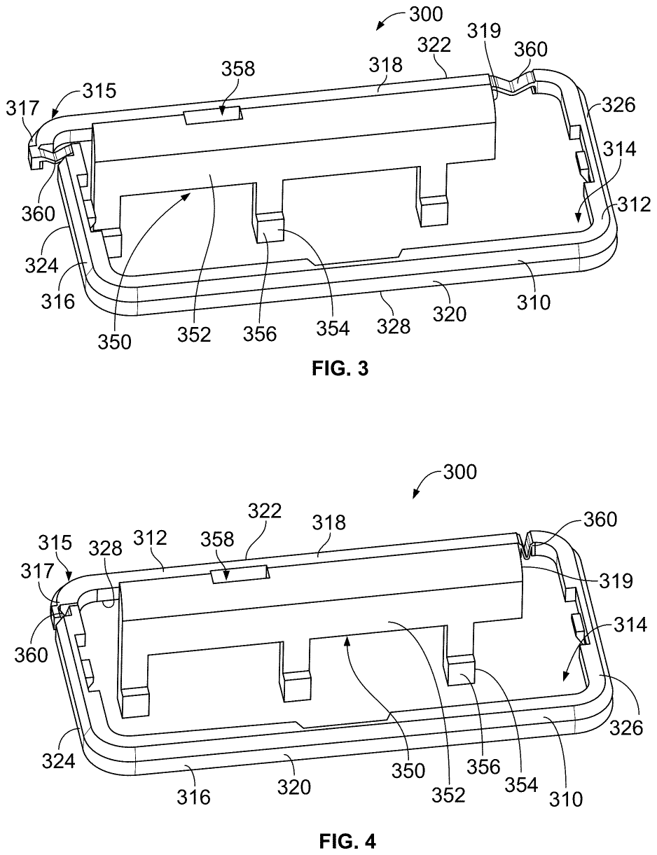

FIG. 3 is a bottom perspective view of the seal retainer 300 showing the TPA device 350 in an extended position. FIG. 4 is a bottom perspective view of the seal retainer 300 showing the TPA device 350 in an actuated position. The seal retainer 300 includes a frame 310. The frame 310 includes frame members 312 surrounding a central opening 314. For example, the frame 310 may be generally ring-shaped extending circumferentially around the opening 314. The frame 310 may be generally rectangular shaped. However, the frame 310 may have other shapes in alternative embodiments.

In an exemplary embodiment, the frame 310 includes a nested portion 316 and a sliding portion 318 movable relative to the nested portion 316. The nested portion 316 is configured to be nested (for example, fixed) in the seal pocket 240 of the housing 200. The sliding portion 318 is movable relative to the housing 200. For example, FIG. 3 shows the sliding portion 318 in the extended position and FIG. 4 shows the sliding portion 318 in the actuated position.

In an exemplary embodiment, the frame members 312 include a front frame member 320, a rear frame member 322, a first side frame member 324, and a second side frame member 326. The side frame members 324, 326 extend between the front and rear frame members 320, 322. In the illustrated embodiment, the front and rear frame members 320, 322 are longer than the side frame members 324, 326. In an exemplary embodiment, the frame members 312 include inner surfaces 328 at the tops of the frame members 312. The inner surfaces 328 are configured to interface with the peripheral seal 290 to hold the peripheral seal 290 in the seal pocket 240.

In an exemplary embodiment, the TPA device 350 extends from the frame 310. In the illustrated embodiment, the TPA device 350 extends form the sliding portion 318. For example, the TPA device 350 extends from the top of the sliding portion 318. The TPA device 350 is movable with the sliding portion 318. For example, the TPA device 350 is movable between the extended position and the actuated position. The TPA device 350 moves from an unblocking position (in the extended position) and a blocking position (in the actuated position). The TPA device 350 is configured to block the terminals 250 in the blocking position. The TPA device 350 of the seal retainer 300 is configured to interface with the terminal 250 to assure positioning of the terminal 250 in the housing 200 at the fully loaded position. The TPA device is configured to retain the terminal 250 in the housing 200 in the blocking position.

In an exemplary embodiment, the TPA device 350 includes a base 352 and one or more locking fingers 354 extending from the base 352. The TPA device 350 includes a number of locking fingers 354 corresponding to the number of terminals 250. For example, in the illustrated embodiment, the TPA device 350 includes three locking fingers 354; however, the TPA device may include greater or fewer locking fingers 354 in alternative embodiments. Each locking finger 354 includes a blocking surface 356 configured to interface with the corresponding terminal 250. The locking fingers 354 are configured to be received in the openings 218 to interface with the terminals 250 and lock the terminals 250 in the housing 200.

In an exemplary embodiment, the TPA device 350 includes a locking element 358 configured to interface with the housing 200. For example, the locking element 358 is configured to lock the TPA device 350 to the housing 200 in the actuated position. The locking element 358 may be provided at the base 352. In various embodiments, the locking element 358 may be a latch or latching element, such as a catch configured to interface with a latch of the housing 200.

In an exemplary embodiment, the seal retainer 300 includes flexible members 360 extending between the nested portion 316 and the sliding portion 318. In an exemplary embodiment, the sliding portion 318 extends between a first end 317 and a second end 319. The flexible members 360 extend from the first and second ends 317, 318 to connect to the nested portion 316. The flexible members 360 are configured to be flexed to allow the sliding portion 318 to move relative to the nested portion 316. In an exemplary embodiment, the flexible members 360 are living hinges. The flexible members 360 spring bias the sliding portion 318 towards the extended position. The flexible members 360 are flexed as the sliding portion 318 moves from the extended position (FIG. 3) to the actuated position (FIG. 4). For example, the flexible members 360 are V-shaped and configured to bend and fold inward when the sliding portion 318 is moved to the actuated position.

In an exemplary embodiment, the nested portion 316, the sliding portion 318, the TPA device 350, and the flexible members 360 are integral as a unitary one piece body. For example, the nested portion 316, the sliding portion 318, the TPA device 350, and the flexible members 360 may be co-molded during a common molding process, such as an injection molding process. The nested portion 316, the sliding portion 318, the TPA device 350, and the flexible members 360 may be molded from a plastic material such that the seal retainer 300 is a monolithic structure.

In an exemplary embodiment, the sliding portion 318 includes a stub member 315, such as at the first end 317. The stub member 315 is located outward of the nested portion 316, such as offset or standing proud of the first side frame member 324, in the extended position. The stub member 315 is configured to block mating with the mating electrical connector 102 in the extended position (FIG. 3). The stub member 315 provides clearance to allow mating with the mating electrical connector 102 in the actuated position (FIG. 4). The stub member 315 may be aligned with the nested portion 316, such as aligned with the first side frame member 324.

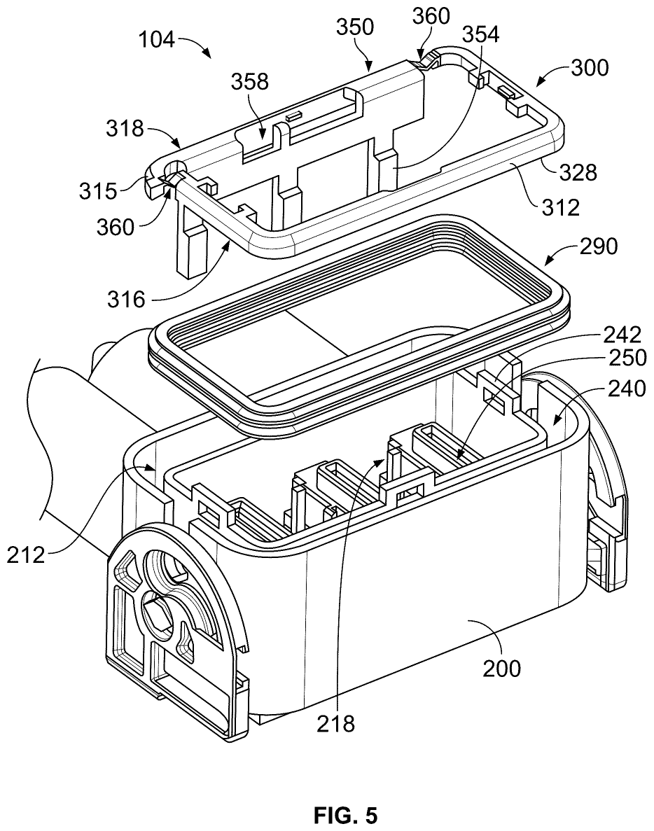

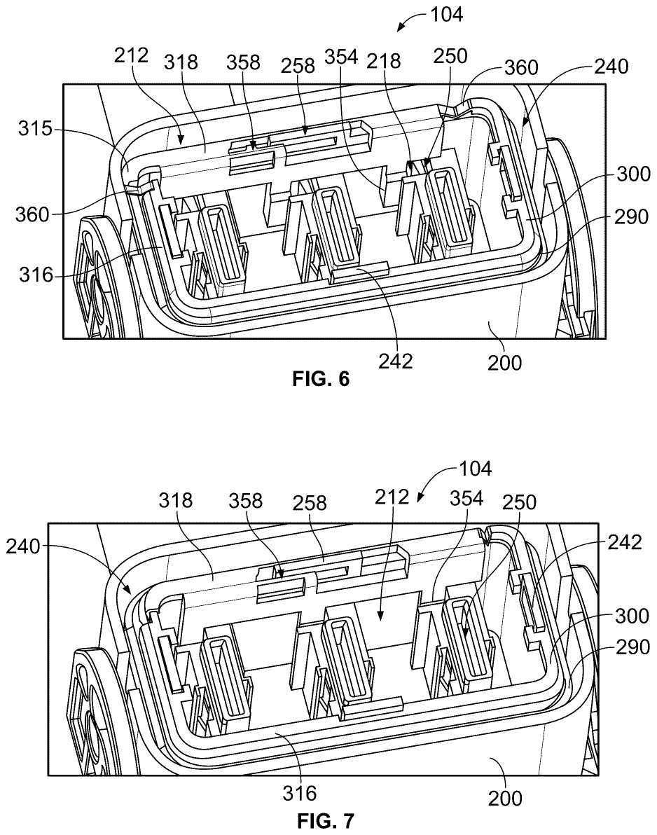

FIG. 5 is an exploded view of the electrical connector 104 in accordance with an exemplary embodiment showing the housing 200 holding the terminals 250 and showing the peripheral seal 290 and the seal retainer 300 poised for loading into the housing 200. FIG. 6 is a bottom perspective, assembled view of a portion of the electrical connector 104 showing the seal retainer 300 in an extended position. FIG. 7 is a bottom perspective, assembled view of a portion of the electrical connector 104 showing the seal retainer 300 in an actuated position.

During assembly, the peripheral seal 290 and the seal retainer 300 are loaded into the seal pocket 240. The latches 242 of the housing 200 are used to hold the seal retainer 300 in the seal pocket 240. The seal retainer 300 holds the peripheral seal 290 in the seal pocket 240. The inner surfaces 328 of the frame members 312 interface with the peripheral seal 290 to hold the peripheral seal 290 in the seal pocket 240. The TPA device 350 of the seal retainer 300 is configured to interface with the terminals 250 in the housing 200 to assure positioning of the terminals 250 in the housing 200 at the fully loaded positions. In an exemplary embodiment, the stub member 315 is configured to block mating with the mating electrical connector 102 in the extended position. For example, the stub member 315 blocks a portion of the cavity 212 and/or seal pocket 240 to block loading of the mating electrical connector 102 into the cavity 212 and/or the seal pocket 240.

The TPA device 350 is movable in the cavity 212 relative to the housing 200 between the unblocking position (associated with the extended position in FIG. 6) and the blocking position (associated with the actuated position in FIG. 7) to retain the terminal 250 in the housing 200 in the blocking position. For example, the TPA device 350 is slidable in the cavity 212 in a direction perpendicular to a mating direction with the mating electrical connector 102. For example, the TPA device 350 may be slidable in a horizontal direction (for example, side-to-side), whereas the mating direction is a vertical direction. In an exemplary embodiment, the flexible members 360 are configured to be flexed when moved or actuated to allow the sliding portion 318 to move relative to the nested portion 316. The flexible members 360 are flexed (for example, compressed) as the sliding portion 318 moves from the extended position to the actuated position. During assembly, the TPA device 350 is moved to the actuated position to move the locking fingers 354 to the blocking positions.

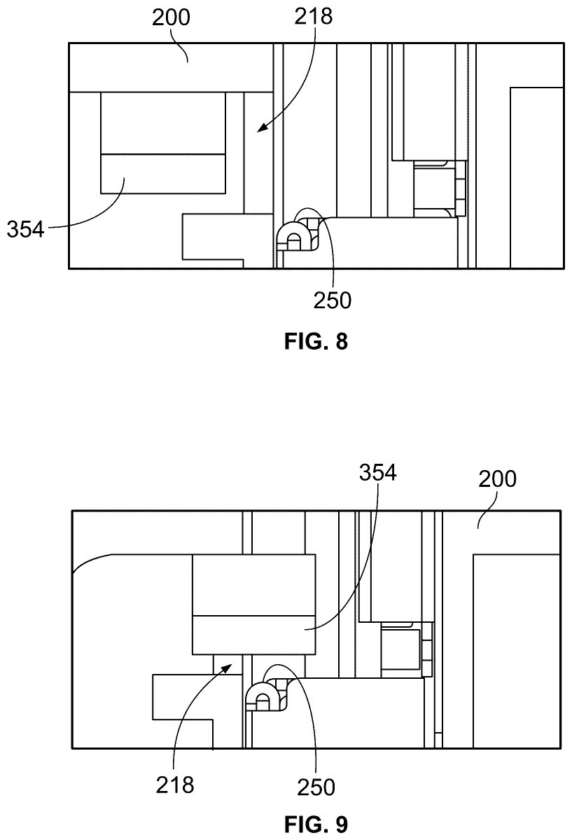

During assembly, the locking fingers 354 are moved to the blocking positions with the TPA device 350. The locking fingers 354 are configured to be received in the openings 218 in the housing 200 to interface with the terminals 250 and lock the terminals 250 in the housing 200 when the terminals 250 are in the fully loaded positions. FIG. 8 shows the locking fingers 354 in unblocking positions, whereas FIG. 9 shows the locking fingers 354 in blocking positions. In the unblocking positions, the locking fingers 354 are offset from the terminals 250 and thus the terminals 250 are able to move into/out of the housing 200. In the blocking positions the locking fingers 354 are aligned with the terminals 250 to block pull-out of the terminals 250 from the housing 200. If the terminals 250 are only partially loaded into the housing 200 (for example, short of the fully loaded positions), the locking fingers 354 are unable to slide into the openings 218 to the blocking positions. For example, the terminals 250 may block or stop sliding of the locking fingers 354, and thus the TPA device 350, to the actuated position, which leaves the stub member 315 in the stubbing position preventing mating with the mating electrical connector 102 thus providing position assurance during mating.

In an exemplary embodiment, the TPA device 350 is configured to be held in the actuated position by the locking element 358. For example, the locking element 358 is configured to interface with a locking element 258 of the housing 200 to hold the TPA device 350 in the actuated position. In the illustrated embodiment, the locking element 258 includes a slot or opening that receives the locking element 358. In an exemplary embodiment, the locking element 358 is deflectable. The locking element 358 may include a protrusion or tab configured to be received in the slot. The protrusion may extend from a deflectable beam that allows the protrusion to move into the slot of the locking element 258.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a housing having walls forming a cavity, the housing having a mating end configured to be mated with a mating electrical connector, the housing including a seal pocket at the mating end;
a terminal received in the housing at a fully loaded position and configured to be mated with the mating electrical connector in the fully loaded position;
a peripheral seal received in the seal pocket, the peripheral seal being sealed to the housing and configured to be sealed to the mating housing when mated with the mating housing; and
a seal retainer received in the seal pocket, the seal retainer including an inner surface configured to interface with the peripheral seal and hold the peripheral seal in the seal pocket, the seal retainer including a terminal position assurance device, the terminal position assurance device of the seal retainer configured to interface with the terminal in the housing to assure positioning of the terminal in the housing at the fully loaded position.

2. The electrical connector of claim 1, wherein the terminal position assurance device is movable in the cavity relative to the housing between an unblocking position and a blocking position, the terminal position assurance device retaining the terminal in the housing in the blocking position.

3. The electrical connector of claim 1, wherein the terminal position assurance device is slidable in the cavity in a direction perpendicular to a mating direction with the mating electrical connector.

4. The electrical connector of claim 3, wherein the terminal position assurance device includes a locking element configured to lock the terminal position assurance device to the housing in an actuated position.

5. The electrical connector of claim 1, wherein the seal retainer includes a frame received in the seal pocket, the terminal position assurance device extending from the frame.

6. The electrical connector of claim 1, wherein the seal retainer includes a nested portion and a sliding portion movable relative to the nested portion between an extended position and an actuated position, the terminal position assurance device extending from the sliding portion and movable with the sliding portion.

7. The electrical connector of claim 6, wherein the sliding portion is coupled to the nested portion by flexible members.

8. The electrical connector of claim 7, wherein the nested portion, the sliding portion, the terminal position assurance device, and the flexible members are integral as a unitary one piece body.

9. The electrical connector of claim 7, wherein the sliding portion extends between a first end and a second end, the flexible members extending from the first and second ends to connect to the nested portion.

10. The electrical connector of claim 7, wherein the flexible members are living hinges.

11. The electrical connector of claim 7, wherein the flexible members spring bias the sliding portion towards the extended position, the sliding portion including a locking member configured to lock the sliding portion to the housing in the actuated position.

12. The electrical connector of claim 7, wherein the flexible members are V-shaped and configured to bend and fold inward when the sliding portion is moved to the actuated position.

13. The electrical connector of claim 6, wherein the sliding portion includes a stub member, the stub member configured to block mating with the mating electrical connector in the extended position, the stub member providing clearance to allow mating with the mating electrical connector in the actuated position.

14. The electrical connector of claim 1, wherein the terminal position assurance device includes a finger configured to interface with the terminal to hold the terminal in the housing.

15. The electrical connector of claim 1, wherein the terminal is a first terminal, the electrical connector comprising a second terminal, the terminal position assurance device configured to interface with the first terminal and the second terminal for terminal position assurance.

16. The electrical connector of claim 1, wherein the housing includes latches configured to latchably hold the seal retainer in the seal pocket.

17. An electrical connector comprising:
a housing having walls forming a cavity, the housing having a mating end configured to be mated with a mating electrical connector, the housing including a terminal channel, the housing including a seal pocket at the mating end;
a terminal received in the terminal channel of the housing to a fully loaded position, the terminal configured to be mated with the mating electrical connector in the fully loaded position;
a peripheral seal received in the seal pocket, the peripheral seal being sealed to the housing and configured to be sealed to the mating housing when mated with the mating housing; and
a seal retainer including a frame received in the seal pocket, the frame having an inner surface configured to interface with the peripheral seal and hold the peripheral seal in the seal pocket, the seal retainer including a terminal position assurance device extending from the frame, the terminal position assurance device including a finger configured to be received in the terminal channel to interface with the terminal to assure positioning of the terminal in the housing at the fully loaded position.

18. An electrical connector comprising:
a housing having walls forming a cavity, the housing having a mating end configured to be mated with a mating electrical connector, the housing including a seal pocket at the mating end;
a terminal received in the housing at a fully loaded position, the terminal configured to be mated with the mating electrical connector in the fully loaded position;
a peripheral seal received in the seal pocket, the peripheral seal being sealed to the housing and configured to be sealed to the mating housing when mated with the mating housing; and
a seal retainer including a frame received in the seal pocket, the frame having an inner surface configured to interface with the peripheral seal and hold the peripheral seal in the seal pocket, the frame including a nested portion and a sliding portion, the sliding portion being movable relative to the nested portion between an extended position and an actuated position, the seal retainer including a terminal position assurance device extending from the sliding portion of the frame, the terminal position assurance device moving with the sliding portion from the extended position to the actuated position and configured to interface with the terminal in the actuated position to assure positioning of the terminal in the housing at the fully loaded position.

19. The electrical connector of claim 18, wherein the terminal position assurance device is movable in the cavity with the sliding portion relative to the housing between an unblocking position and a blocking position, the terminal position assurance device retaining the terminal in the housing in the blocking position.

20. The electrical connector of claim 18, wherein the sliding portion is coupled to the nested portion by flexible members, the nested portion, the sliding portion, the terminal position assurance device, and the flexible members are integral as a unitary one piece body.
